(19) United States
(12) Patent Application Publication
(10) Pub. No.: US 2019/0114323 A1
(43) Pub. Date: Apr. 18, 2019

(54) System And Method For Storing Data Records In Key-Value Database

(71) Applicant: DataJaguar, Inc., Danville, CA (US)

(72) Inventor: Jonathan Zhanjun Yue, Danville, CA (US)

(21) Appl. No.: 16/160,236

(22) Filed: Oct. 15, 2018

Related U.S. Application Data
(60) Provisional application No. 62/606,918, filed on Oct. 13, 2017.

(51) Int. Cl. G06F 17/30

(52) U.S. Cl. CPC G06F 17/3012; G06F 17/30949

(57) ABSTRACT

When a new data record enters the system for storage, key router verifies if the key in the data record already exists in one of the data files (file 106, 108, 110, and 112). If the key exists, the new data record is rejected. Otherwise, key router assigns a file number to the record and directs the system to store the record in the data file corresponding to the file number.

### CROSS REFERENCES TO RELATED APPLICATIONS

The present Application claims the benefit of U.S. Provisional Application No. 62/606,918, filed Oct. 13, 2017 by the same inventor as the present application and directed to the same invention and containing the same disclosure as the present application.

### TECHNICAL FIELD

The present invention relates to a method for storing information in a data processing system and, in particular, to a method for storing data records in key-value database.

### BACKGROUND OF THE INVENTION

An existing problem in computer-based data processing systems is that data is being generated and consumed at unprecedented scale, primarily due to wide adoption of mobile devices and Internet of Things. Current systems are inadequately equipped to deal with this “big-data” phenomenon.

This problem of overwhelming amounts of data has caused various novel approaches. For example, scalable NoSQL (Not Only SQL) database system have been developed to manage ever-increasing data volume. What is needed is a system and method to improve the storing of data records in such database systems. The methods of storing records in the present invention provide a solution to these and other problems of the prior art.

### SUMMARY OF THE INVENTION

In this invention, we describe our system and method for storing data records in key-value database. A key-value database is one of the categories of NoSQL databases. Data records consisting of a key and a value are distributed in multiple data files in a database system. The terms “data file” and “file” will be used interchangeably without any important difference. The term “file number” means a serial number identifying a data file, normally starting from 1. The term “user” refers to a person or a client program that may insert, read, update, or delete data in the database system. The term “server” can represent a physical computer with CPU, memory, permanent storage medium, or a virtual server instance in a cloud environment. In the database system, one or more servers may be deployed to receive data from a user or provide data to the user. In each server, one more data files can be used to store key-value data records. The key in a data record uniquely identifies the record in the whole database system. The value in the data record contains all data in the record except the key. The key may consist of multiple data items, i.e., the key may be a composite key.

In the present invention we store data records in multiple data files on a computer server which may be a stand-alone server or one of the servers in a cluster environment where multiple servers are deployed. The reason to use multiple data files to store data on a computer server may be one of the following: (1) in a modern storage system, such as solid state drive (SSD) or other types of electronic non-volatile computer storage medium, concurrent data write and read operations on multiple files have advantage over a single file; (2) each file can be associated with a tag or a range allowing precise and faster retrieval of data that has the same association; (3) multiple files enable more fault tolerance because once a file is corrupted, only one file is affected, not all the remaining files.

### BRIEF DESCRIPTION OF THE FIGURES

The foregoing and other objects, features and advantages of the present invention will be apparent from the following description of the invention and embodiments thereof, as illustrated in the accompanying figures, wherein:

FIG. 1 schematically depicts our storage model where an input data record, a key router, and multiple data files are displayed.

FIG. 2 illustrates record routing process in the key router.

FIG. 3 is a flow chart diagram illustrating the steps in key routing process.

FIG. 4 depicts one embodiment of managing multiple data files with new files.

FIG. 5 depicts another embodiment of managing multiple data files with round-robin.

FIG. 6 illustrates another embodiment of managing multiple files with hashing.

### DETAILED DESCRIPTION

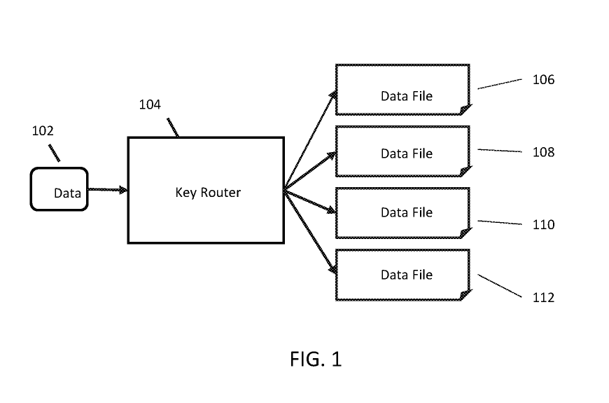

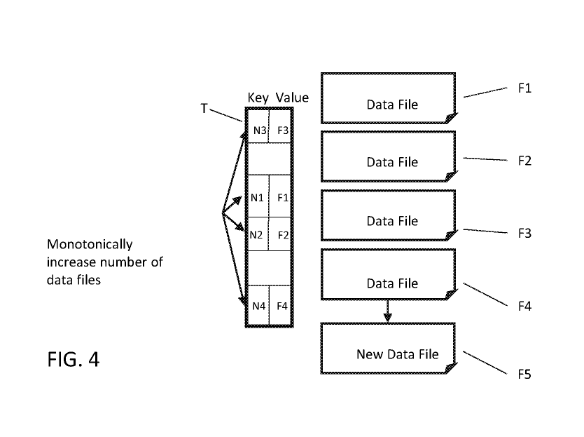

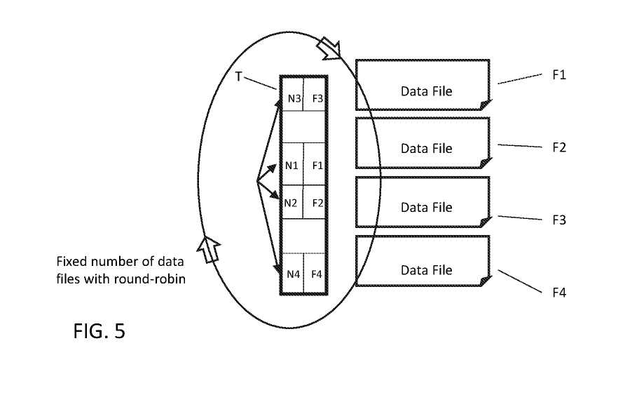

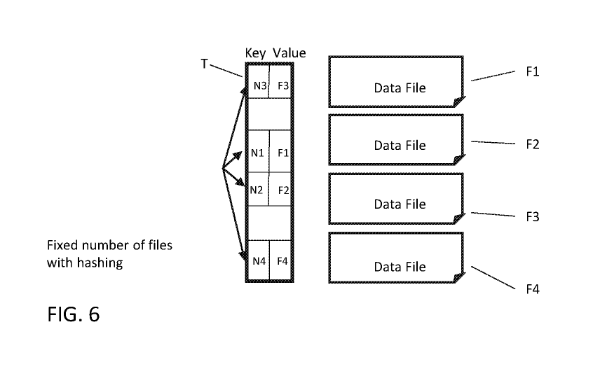

Referring to schematic diagram FIG. 1, when a new data record 102 enters the system for storage, key router 104 verifies if the key in the data record already exists in one of the data files (file 106, 108, 110, and 112). If the key exists, the new data record is rejected. Otherwise, key router 104 assigns a file number to the record 102 and directs the system to store the record 102 in the data file corresponding to the file number. The method for assigning file numbers to data records will be illustrated in FIG. 4, FIG. 5, and FIG. 6. In another embodiment, if the key in the record already exists in the key router, the new data records is not rejected but is used to update the existing record that has the same key.

To fetch the data record associated with a key, the key is provided to the key router which checks if the key exists in it. If the result is negative (the key does not exist), then a negative answer is returned to the user. If the result is positive, the key router provides the correct file number and directs the system to fetch data in the corresponding file. A file number can be uniquely mapped to a file name, for example, “user_n”, where n is the file number. The data file name can be in any format, as long as the file name is uniquely associated to the file number. The key router can be kept in volatile memory or in non-volatile memory. The key router also provides the data file number when searching for a data record.

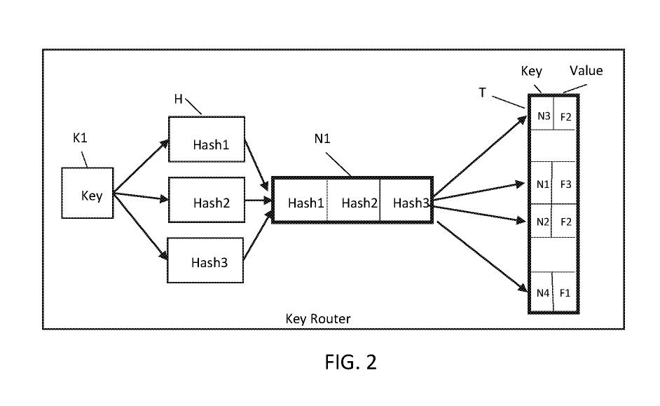

FIG. 2 is a block diagram illustrating the process of record routing which is associating a record key with a file number so that the system can determine which file is used to store a data record or fetch a data record. When a key K1 enters the key router, one or more hash functions are applied to the key, simultaneously or sequentially. The hash functions may be MD5, MD4, Murmur hash, or any other independent hash function. The hash values generated from the hash functions are shown as Hash1, Hash2, and Hash3. Then these hash values are concatenated, or shuffled in anyway, into a combined value N1. In another embodiment, no value or only partial value of hash2 or hash3 may participate in the concatenation or shuffling to form the combined value N1. The value of N1 is again hashed with a hash function and then N1 is saved in a hash table T. In the hash table T, symbol N2, N3, and N4 represent concatenated hash values of other input record keys for illustration purpose. Symbols F1, F2, and F3 represent data file numbers. In another embodiment of the present invention, if the number of bits in the combined hash value N1 is more than the number of bits in the original key K1, then values of Hash1, Hash2, Hash3, and N1 are not obtained, and the original key K1 is hashed directly and saved into hash table T.

The purpose of comparing the number of bits is to reduce resource consumption because shorter hash keys in hash table T use less memory and storage space. In the hash table T, key-value data pairs are stored. Note that the key-value data pair is different from the original key-value pair to be stored in our database system. In the hash table T, the key or the hash key is the combined hash value N1, or original key K1 in the case that the number of bits in K1 is less than the number of bits in N1. The value part associated with the hash key in T is a file number which is a non-zero natural number. The file number may use one byte to identify a total of 256 data files, or two bytes to identify a total of 256×256=65536 data file, or three bytes to identify a total of 256×256×256=17,777,216 files, or more bytes to identify more files.

Comparing the number of bits in key K1 and the number of bits in the combined value N1 may be performed online when each data record enters the system or offline when a schema of the database is initially designed. Here, the number of bits in N1 may not need actual counting. It can be determined by the way how Hash1, Hash2, and Hash3 are combined to construct N1. Normally a hash function generates a fixed-length hash value. For example, a MD5 hash function creates a 128-bit hash value. Determining the number of bits in N1 can be generally expressed with the following formula:

B(N1)=B(P(Hash1))+B(P(Hash2))+B(P(Hash3))

where P(Hash) means selecting all the bits or only part of the bits in Hash, and B(P) means the total number of bits in P. For example, all the bits in Hash1 may be selected, while only the first 16 bits in Hash2 selected, and none of the bits in Hash2 selected.

It should be noted that when the original key K1 is used as the hash key in the hash table T, mapping K1 to file numbers is lossless, meaning the system can always find the correct file number for a given key K1 in a data record. However, when the combined hash N1 is used as the hash key in the hash table T, mapping original record key K1 to file numbers may be lossy, meaning the system does not guarantee to find the correct file number for a given key K1 in a data record. The lossy mapping happens when the number of all possible values of key K1 is greater than the number of all possible values of the combined hash value N1 because of hash collision. In certain application scenarios, lossy mapping is acceptable since some data records can be dropped while entering the database system. Storing all data records in the database is not strictly required. Nevertheless, one can always use more hash values to construct the combined hash value N1 in order to decrease the possibility of lossy mapping.

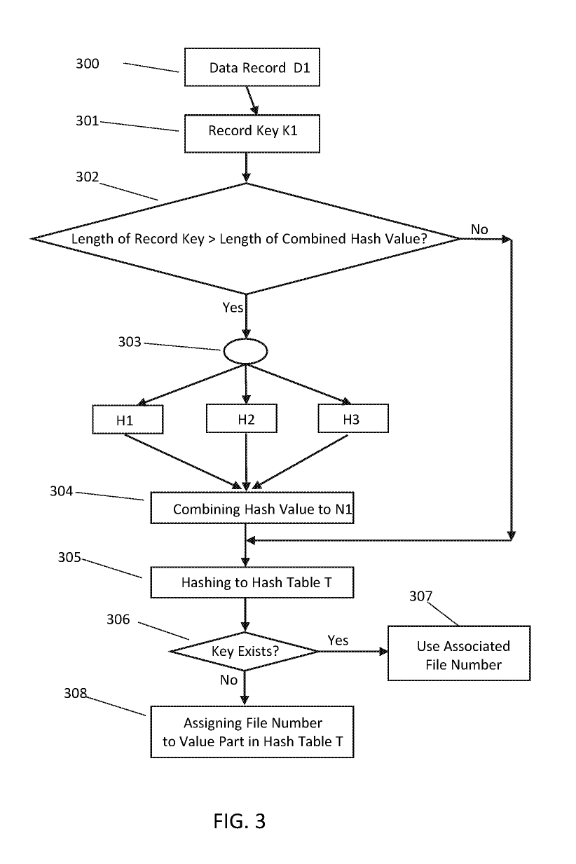

FIG. 3 is a flow chart diagram that provides the process flow for FIG. 2. At step 300, a data record D1 enters the system. In the next step 301, the system extracts the record key K1 from the data record. In step 302, the length (total number of bits) of the record key K1 is compared with the length of combined hash value (which is known at design time). If the length of the record key K1 is less than or equal to the length of the combined hash value, the flow goes to step 305 directly. Otherwise, the flow goes to step 303, which computes hash values of the record key K1 with different hash functions, concurrently or sequentially, to obtain the hash values H1, H2, and H3 (or more hash values). In step 304, the hash values are then combined into one value N1 through concatenation or shuffling of H1, H2, and H3. In step 305, the combined value N1 or the original record key K1 are hashed into hash table T. Step 306 checks if the hash key (N1 or K1) already exists in the hash table T. If the answer is yes, then the flow goes to step 307 to use the file number corresponding to the hash key from the hash table T. If the answer is no, then in step 308, a file number is assigned to the value part associated with the hash key in the hash table T.

The file number assigned to the value part associated with a hash key in hash table T may be determined with one of the methods described below.

FIG. 4 schematically demonstrates assigning file numbers to value parts associated with their hash keys in hash table T. All data files F1, F2, . . . , F4 have a predefined size limit either in terms of file size in bytes or in terms of total number of data records in the file. Initially all the data records are stored in file F1, hence number 1 is assigned to the file numbers as the value part in T. File F1 is called the “active” file. As more data records enter the system and when file F1 is full, the records are stored in file F2, and number 2 is assigned to the value part in T for all the new records. File F2 becomes the active file. Similarly, when file F2 is full, number 3 is assigned to the value part in hash table T1 for the new records, so on and so forth.

FIG. 4 illustrates that when files F1, F2, F3, F4 are all full, a new file F5 is created as the active file to store the new records and file numbers are used in hash table T for the combined hash key (or K1). Only one file is active for assigning file numbers to new data records. In another embodiment, new data files are created according to a chronological order instead of file size limit. For example, a new data file may be created for each new month, week, or day. In another embodiment, the file number in hash table T can be replaced with file names directly. In the present invention, the actual number of data files are unlimited. The total number of files can be increased to any number.

FIG. 5 illustrates another method to assign file numbers to the value part associated with the hash keys in hash table T. A predefined number of data files are created and used to store data records in round-robin fashion. The data files form a file pool. The data file that is in the process of storing incoming new data records is the active file. A group of data records may be stored in the active file. The total number of records in the group can be any number, including one. After the group of records are stored in the active file, the next group of records are stored in the next file which becomes the active file. In FIG. 5 only 4 files are shown. However, the number of files is not limited to 4. Initially the first group of records are stored in file F1, hence number 1 is assigned to the file numbers as the value part in T. As more data records enter the system, another group of records are stored into file F2. Number 2 is assigned to the value part of hash table T for these records. Similarly, new group of records are stored in file F3, with number 3 assigned to the value part in hash table T for these batch of records. Similarly, new group of records are stored in file F4, with number 4 assigned to the value part in hash table T for these records. Assuming file F4 is the last file in the file pool, then when new records enter the system, they will be stored back to file F1. Number 1 is assigned to the hash values in hash table T. This round-robin pattern continues so the system can store more data records in the data files.

FIG. 6 illustrates another method to assign file numbers to the value part associated with the hash keys in hash table T. A predefined number of data files, a pool of files, are created and used to store data records in round-robin fashion. The total number of data files, denoted by M, can be any non-zero natural number. When a new data record enters the system, its hash key in hash table T is again mapped to one of the numbers between 0 and M−1, inclusive. Two methods can be used to map the hash key in T to a value between 0 and M−1: (1) the hash key in T can be hashed with an independent hash function and the result number is taken modulo M; (2) the index number of the hash key in hash table T can be taken modulo M if an array of buckets or slots are used in hash table T. Any other method can be used to map hash key in T to M data files. The method shown in FIG. 5 does not guarantee that each of the M data files has at least one data record.

The hash table T has the capability of associating a key with a value. Hash table T can be replaced with other data structures that can associate keys with values. For example, a binary search tree, or a B−Tree can be used to replace the hash table T.

In the previous descriptions, we have not described how data records are stored in the data files. Any method can be used to store data records in a data file. In one embodiment, new data records are simply appended to the end of the data file. Simply appending records to end of file is fast in data-write but slow in data-read since finding a data record in the file may require whole-file scan for the data record. In another embodiment, a data file can be organized with a B−Tree or B+Tree structure so new data records are inserted into the data file according to the rules of such tree structure. In another embodiment, a data file can be organized with a SEA (Sorted Elastic Array) structure, a sparse array, so new data records are inserted in the data file according to the rules of SEA structure. In another embodiment, new data records can first be cached in memory and sorted by the keys in memory, and finally written to the data files according to the same key order in memory.

For reading, updating, and deleting operations of a data record, the system can use the key router to find the file number and the corresponding file and then reads, updates, or deletes the record in the date file. Locating the data file for a record key follows the same process as storing new records in constructing the hash key in hash table T, and retrieving the value part as file number in the hash table T. Deletion of records in data files can affect the decision in selecting a data file for storing new data records. In one embodiment, if a significant portion of records, for example 30%, have been deleted in a data file, then this file may be used as the next file or active file for storing new data records. In another embodiment, the data file that contains the least number of data records among all existing data files and has a total number of data records that is significantly less than other files, for example 20%, can be used as the next file or active file to store the new records. If such criteria are not met, then the presented methods in FIG. 4, FIG. 5, FIG. 6 will be used to determine the data files.

Multiple data files can be grouped by different entities. In relational database terms, the entities can be represented by “tables”. In NoSQL database terms, the entities can be represented by “collections”. For example, a “member” table or collection can have its own group of data files for storing membership data records. A “device” table or collection can have its own group of data files to manage all physical devices in an application scenario. The records, record keys, key router in different groups of data files are considered independent.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. A method, comprising:
entering a new data record into a computer system for storage, wherein the computer system contains a plurality of data files;
extracting a record key from the new data record;
verifying, by a key router, if the extracted record key already exists in one of the plurality of data files, wherein the verifying further comprises checking a hash table;
setting the new data record for further processing if the new key exists;
if the key does not exist, assigning, by the key router, a file number to the new data record and directing the system to store the new data record in a data file in the plurality of data files corresponding to the file number.

2. The method of claim 2, wherein verifying further comprises comparing the length of the record key with the length of a combined hash value.

3. The method of claim 2, wherein verifying further comprises computing, if the length of the record key is greater than the combined hash value, the hash values of the record key K1 with a plurality of hash functions to obtain a plurality of hash values, and then combining the plurality of hash values into one combined hash value and checking if the combined hash value already exists in the hash table.

4. The method of claim 3, where setting the new data record for further processing further comprises rejecting the new key record.

5. The method of claim 3, where setting the new data record for further processing further comprises updating an existing record that has the same key.

6. The method of claim 3, wherein assigning a file number further comprises assigning based on value parts associated with their hash keys in the hash table.

7. The method of claim 3, wherein assigning a file number further comprises assigning based on chronological order.

8. The method of claim 3, wherein a predefined number of data files are created and used to store data records in a round-robin fashion, and wherein the predefined number data files form a file pool, the data file that is in the process of storing incoming new data records is an active file, and a group of data records may be stored in the active file, and after the group of records are stored in the active file, the next group of records are stored in the next file which becomes the active file.

9. One or more non-transitory computer-readable storage media having stored therein instructions, which when executed by an electronic device, cause the electronic device to perform acts comprising:, comprising:
entering a new data record into a computer system for storage, wherein the computer system contains a plurality of data files;
extracting a record key from the new data record;
verifying, by a key router, if the extracted record key already exists in one of the plurality of data files, wherein the verifying further comprises checking a hash table;
setting the new data record for further processing if the new key exists;
if the key does not exist, assigning, by the key router, a file number to the new data record and directing the system to store the new data record in a data file in the plurality of data files corresponding to the file number.

10. The one or more non-transitory computer readable storage media of claim 9, wherein verifying further comprises comparing the length of the record key with the length of a combined hash value.

11. The one or more non-transitory computer readable storage media of claim 9, wherein verifying further comprises computing, if the length of the record key is greater than the combined hash value, the hash values of the record key K1 with a plurality of hash functions to obtain a plurality of hash values, and then combining the plurality of hash values into one combined hash value and checking if the combined hash value already exists in the hash table.

12. The one or more non-transitory computer readable storage media of claim 10, where setting the new data record for further processing further comprises rejecting the new key record.

13. The one or more non-transitory computer readable storage media of claim 10, where setting the new data record for further processing further comprises updating an existing record that has the same key.

14. The one or more non-transitory computer readable storage media of claim 10, wherein assigning a file number further comprises assigning based on value parts associated with their hash keys in the hash table.

15. The one or more non-transitory computer readable storage media of claim 10, wherein assigning a file number further comprises assigning based on chronological order.

16. The one or more non-transitory computer readable storage media of claim 10, wherein a predefined number of data files are created and used to store data records in a round-robin fashion, and wherein the predefined number data files form a file pool, the data file that is in the process of storing incoming new data records is an active file, and a group of data records may be stored in the active file, and after the group of records are stored in the active file, the next group of records are stored in the next file which becomes the active file.

17. A system comprising:
one or more processors;
memory accessible by the one or more processors; and
one or more modules stored in the memory and executable by the one or more processors to:
enter a new data record into a computer system for storage, wherein the computer system contains a plurality of data files;
extract a record key from the new data record;
verify, by a key router, if the extracted record key already exists in one of the plurality of data files, wherein the verifying further comprises checking a hash table;
set the new data record for further processing if the new key exists;
if the key does not exist, assign, by the key router, a file number to the new data record and directing the system to store the new data record in a data file in the plurality of data files corresponding to the file number.

18. The system of claim 17, wherein verifying further comprises comparing the length of the record key with the length of a combined hash value.

19. The system of claim 18, wherein verifying further comprises computing, if the length of the record key is greater than the combined hash value, the hash values of the record key K1 with a plurality of hash functions to obtain a plurality of hash values, and then combining the plurality of hash values into one combined hash value and checking if the combined hash value already exists in the hash table.

20. The system of claim 19, where setting the new data record for further processing further comprises rejecting the new key record.
